(19) United States
(12) Patent Application Publication
(10) Pub. No.: US 2012/0313432 A1
(43) Pub. Date: Dec. 13, 2012

(54) POWER DISTRIBUTION SYSTEM CONNECTING APPARATUS

(75) Inventor: Noboru WAKABAYASHI, Yokohama (JP)

(73) Assignee: Hitachi Consumer Electronics Co., Ltd.

(21) Appl. No.: 13/487,560

(22) Filed: Jun. 4, 2012

(30) Foreign Application Priority Data
Jun. 10, 2011 (JP) 2011-129773

(51) Int. Cl. H02J 3/00

(52) U.S. Cl. 307/24

(57) ABSTRACT

A power distribution system connecting apparatus comprises a power generation amount calculating portion for calculating a theoretical amount of power generation of the power source apparatus from an environment measurement value, a power measuring portion for measuring an amount of power generation of the power source apparatus, a comparator portion for comparing the calculation value of the power generation amount calculating portion and the measurement value of the power measuring portion, a memory portion for memorizing a result of comparison in the comparing portion, and a display portion for displaying a condition of the power source apparatus thereon; thereby providing the power distribution system connecting apparatus for enabling to deal with suppression of a reverse power flow, while preventing ill-influences due to troubles from being transferred to a system side.

This application relates to and claims priority from Japanese Patent Application No. 2011-129773 filed on Jun. 10, 2011, the entire disclosure of which is incorporated herein by reference.

### BACKGROUND OF THE INVENTION

The present invention relates to a power distribution system (hereinafter, being called by only “system”) linking or connecting apparatus.

As the background of the present technical field, for example, Japanese Patent Laying-Open No. 2010-11705 (the following Patent Document 1) is already known. In this publication is described “for providing a system connecting apparatus, a system connecting system, a power transmission system and a controlling apparatus, for enabling fair reverse power flow among respective users and stabilization of voltages in the power distribution system (e.g., a bank), as the problem to be dissolved, a system connecting apparatus, to be connected with the power distribution system (e.g., the bank), to which AC electric power is supplied, and with an electric power source apparatus, which is provided at the user, dissolves the problem by comprising a receiving portion for receiving reverse power flow information, including a reverse power flow electric energy suppressing instruction for instructing to suppress the reverse power flow electric energy to be transmitted from the electric power source apparatus to the power distribution system from a predetermined transmission route, and a controlling portion for achieving suppression of the reverse power flow electric energy” (see Abstract thereof). Also is already known Japanese Patent Laying-Open No. 2009-268247 (the following Patent Document 2). In this publication is described “for suppressing the reverse power flow towards a transformer station by a unit of a user, as the problem to be dissolved, a demand IF measures the flow of electric energy at a power receiving point, and also calculates out a target value to be an upper limit value of the reverse power flow of electric energy at the power receiving point, and when the flow measured comes to be the reverse power flow having an amount exceeding the target value, the electric energy generated by distributed-type power sources is charged into a battery, so as to dissolve the problem” (see Abstract thereof).

### PRIOR ART DOCUMENTS

### Patent Documents

[Patent Document 1] Japanese Patent Laying-Open No. 2010-11705 (2010); and
[Patent Document 2] Japanese Patent Laying-Open No. 2009-268247 (2009).

### BRIEF SUMMARY OF THE INVENTION

Within the Patent Document 1 mentioned above, there is described a mechanism of the system connecting apparatus for suppressing the reverse power flow of electric energy from a user or consumer, upon basis of the reverse power flow information. However, the system connecting apparatus disclosed in the Patent Document 1 suppresses only a total amount of power generation within the consumer; but never describes therein a suppressing method for each electric power source apparatus.

In such the system connecting apparatus as was mentioned above, for example, when trying to suppress the amount of power generation by two (2) sets of the electric power source apparatuses within the consumer, upon basis of the reverse power flow information, it suppresses the amount of power generations of both of them. Also, for example, when either one of them is in a trouble, it is necessary to increase the amount of power generations of the remaining one. In general, during the time-period when works and/or companies or the like, consuming a lot of electric power, are in holidays for long time, such as, Golden weeks, etc., for example, a supply amount of electric power decreases down, i.e. the reverse power flow is suppressed for a long time. In the system connection apparatus described in the Patent Document 1 mentioned above, all of the electric power source apparatuses are controlled on the amount of power generation thereof, within the consumer. Those fluctuations of the amount of power generation result into a load for the electric power source apparatus.

Also, in the Patent Document 2 mentioned above is described a mechanism for charting an excess amount of the power generation is charged into the battery(ies). However, in the Patent Document 2, it is necessary to provide the battery(ies) within the consumer.

Also, in the Patent Document 1 and the Patent Document 2 mentioned above, there is no description about a mechanism when the power generating apparatus shows a sign of trouble, in a normal operation thereof. When the power generating apparatus shows the sign of trouble, a possibility that the apparatus falls into trouble is high, and there is also a possibility that ill-influences of the trouble may be transferred to the system side.

Then, according to the present invention, an object thereof is to provide a (power distribution) system connecting apparatus for preventing the ill-influences of the trouble from being transferred to the system side, and also being able to deal with suppression of the reverse power flow, with reducing the load on each electric power source apparatus.

For accomplishing the object mentioned above, according to the present invention, the structures, which will be mentioned later, for example, are adopted.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 shows an example of the configuration view of a system connecting apparatus between a system and a consumer;

FIG. 2 shows an example of the configuration view of the system connecting apparatus;

FIG. 3 shows an example of a reliability estimation table;

FIG. 4 shows an example of a flowchart for showing steps to registering the reliability estimation table;

FIG. 5 shows an example of a flowchart for showing steps to conduct reliability estimation and parallel off;

FIG. 6 shows an example of a flowchart for showing steps to conduct the reliability estimation;

FIG. 7 shows an example of a flowchart for showing steps to execute the parallel off;

FIG. 8 shows an example of the reliability estimation table;

FIG. 9 shows an example of the configuration view of the system connecting apparatus between the system and the consumer;

FIG. 10 shows an example of the configuration view of the system connecting apparatus;

FIG. 11 shows an example of a flowchart for showing steps to conduct reliability estimation and parallel off;

FIG. 12 shows an example of a flowchart for showing steps to conduct the reliability estimation;

FIG. 13 shows an example of a display in the system connecting apparatus;

FIG. 14 shows an example of a display screen in the system connecting apparatus; and

FIG. 15 shows an example of an en environment measuring apparatus table enable with a distributed-type power source.

### DETAILED DESCRIPTION OF THE PREFERRED EMBODIMENTS

Hereinafter, embodiments according to the present invention will be fully explained by referring to the attached drawings.

### Embodiment 1

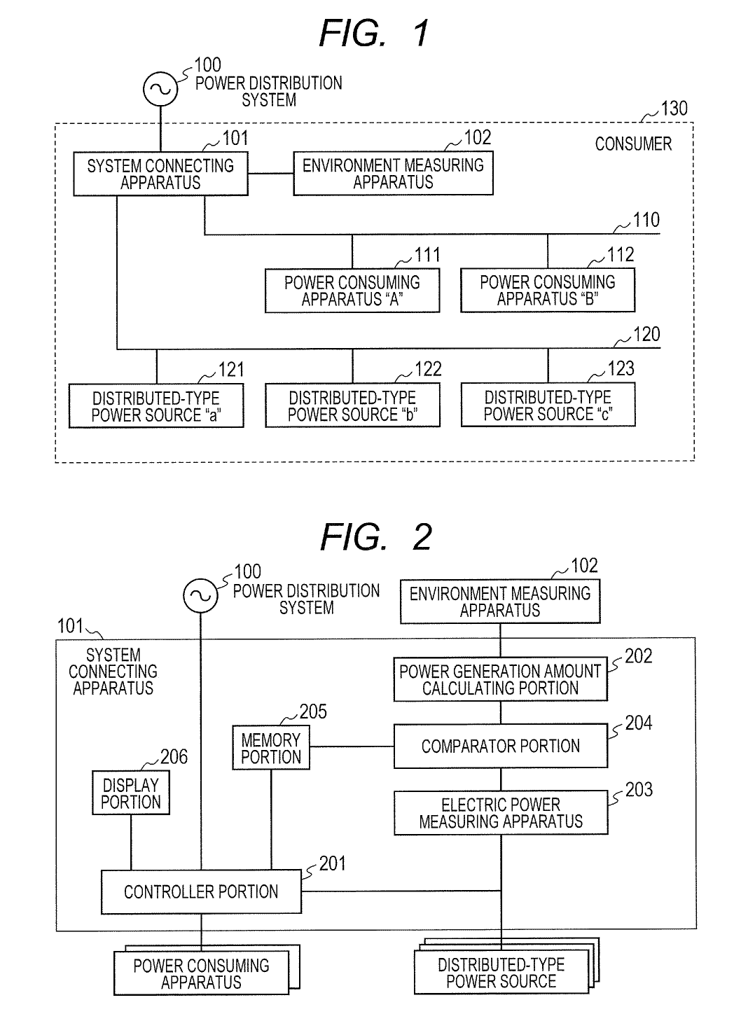

The present embodiment is one (1) embodiment of the system connecting apparatus according to the present invention. Explanation will be given on the present embodiment, by referring to FIGS. 1 to 5, 8 and 13 to 13.

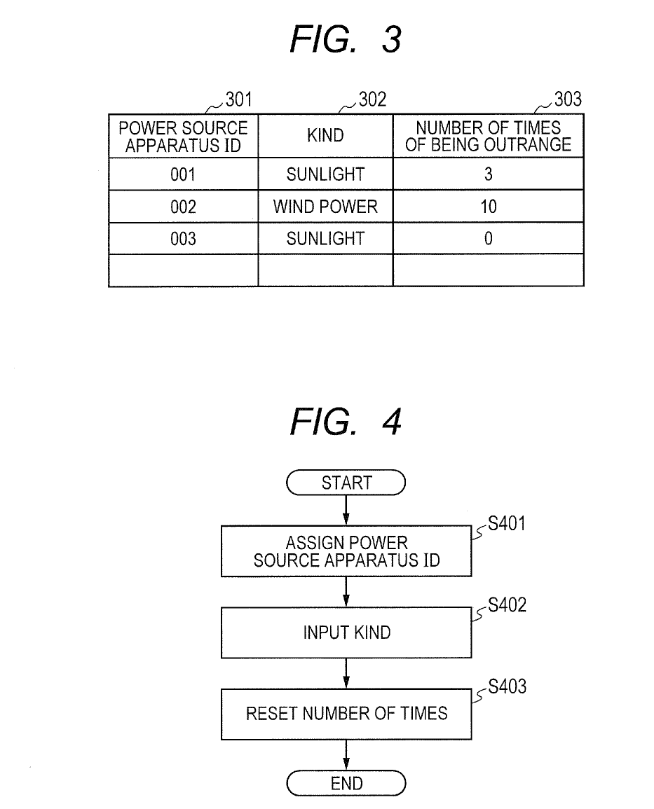

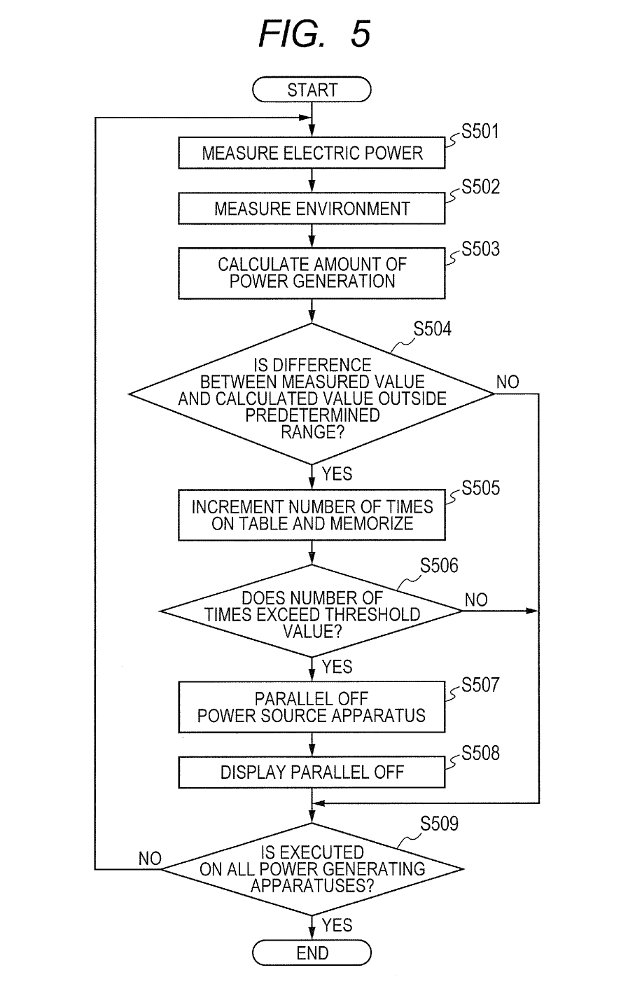

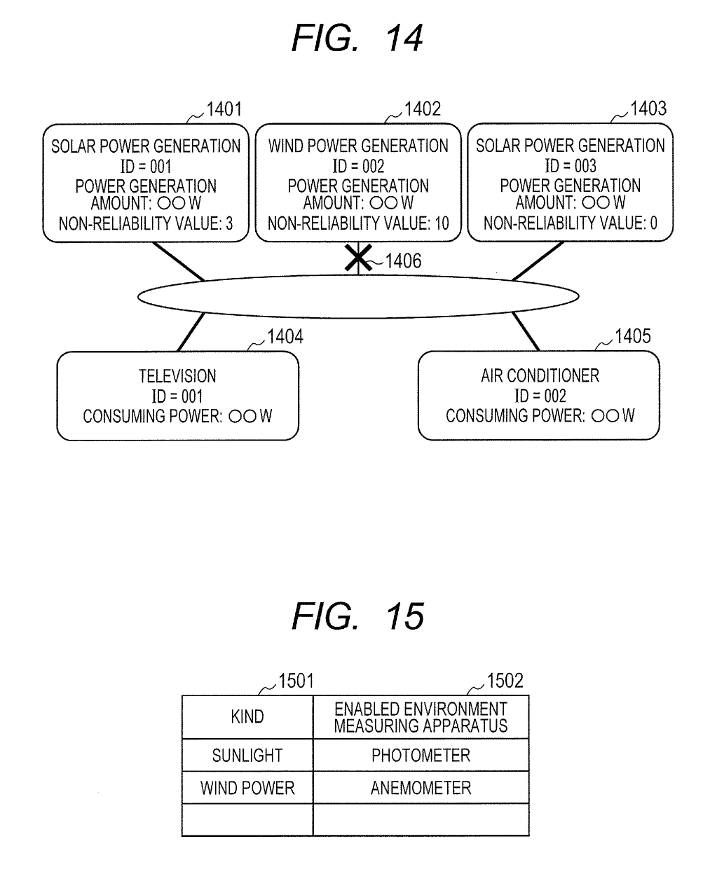

FIG. 1 is a view for showing the configuration of a (power distribution) system connecting apparatus between a (power distribution) system and a consumer, according to an embodiment, FIG. 2 is a block diagram of the system connecting apparatus according to the present embodiment, FIG. 3 is a view for showing a reliability estimation table according to the present embodiment, FIG. 4 is a flowchart for conducting registration process of the reliability estimation table, in the system connecting apparatus according to the present embodiment, FIG. 5 is a flowchart for conducting reliability estimation and parallel off, in the system connecting apparatus according to the present embodiment, FIG. 8 is a view for showing the reliable estimation table, obtained by extending the reliable estimation table shown in FIG. 3, FIG. 13 is a view for showing a display on a display portion, in the system connecting apparatus according to the present embodiment, FIG. 14 is a view for showing a display screen in the present embodiment, and FIG. 15 shows a distributed-type power source enabled environment measuring apparatus table for making correspondence of an en environment measuring apparatus to be suitable thereto.

In FIG. 1, a reference numeral 100 depicts a (power distribution) system for supplying electric power or energy to consumers, including power generation plants and/or transformer stations and/or power distribution systems of an electric power company, etc., and 130 a consumer consuming electric power or energy therein, such as, an ordinary family, etc, respectively. A reference numeral 101 depicts a system connecting apparatus for connecting an electric power source apparatus and an electric power consuming apparatus in the consumer's household with the system, 102 an environment measuring apparatus for measuring the environment, such as, a luminous intensity, a force (or velocity) of wind, temperature, humidity, etc., for example, 111 and 112 an electric power consuming apparatus “A” and an electric power consuming apparatus “B”, 120 distributing wires of a power source apparatus, with which the power source in the consumer's household is connected, and 121, 122 and 123 distributed-type power sources “a”, “b” and “c”, each being connected with the wires of the power source apparatus 120 mentioned above, and being a natural energy power generation or a cogeneration, etc., such as, a sunlight or a wind power, for example, respectively.

Herein, explanation will be given briefly on an outlook of the present embodiment, by referring to FIG. 1. The environment measuring apparatus 102 is installed within the use's household. Therein, the environment measuring apparatus 102 is introduced for calculating an amount of power generation of the distributed-type power source, theoretically. Thus, the environment measuring apparatus 102 is needed by the numbers of kinds of the distributed-type power sources. For example, in case where the distributed-type power source “a” 121 is a solar power generating apparatus, and the distributed-type power source “b” 122 is a wind power generating apparatus, a photometer and an anemometer (a wind gauge) are necessary as the environment measuring apparatuses. The system connecting apparatus 101, comparing a measure value measured by the environment measuring apparatus 102 and an actual amount of power generation of the distributed-type power source corresponding to that, determines there is a possibility that the reliability thereof is low, if the difference between them is equal to or greater than a predetermined value, and memorizes a number of times of being equal to or greater than the predetermined value, on a reliability estimation table. In case where that number comes to be equal to or greater than a certain threshold value, the system connecting apparatus determines that distributed-type power source to be low in the reliability thereof, and execute the parallel off, i.e., cutting off that distributed-type power source from the system. With doing this, it is possible to prevent the ill-influences due to the trouble of the distributed-type power source having the low reliability from being transferred to the system side.

FIG. 2 is a block diagram of the system connecting apparatus 101 according the present embodiment. A reference numeral 201 depicts a controller portion for conducting control on each block within the system connecting apparatus, and this captures an amount of power generation(s) of the distributed-type power source(s) and electric powers consumed in the electric power consuming apparatus(es), so as to distribute the electric power generated by the distributed-type power source(s) to the electric power consuming apparatus(es), and when the amount of power generation exceeds the amount of power consuming, it makes

the reverse power flow of the excess electric power (sales of electric power) is conducted to the system side. Also, it makes a parallel off process of the distributed-type power source and a connection process of connecting the distributed-type power source to the system. A reference numeral 202 depicts a power generation amount calculating portion for calculating a theoretical amount of power generation of the distributed-type power source, 203 an electric power measuring portion for measuring an amount of power generation of the distributed power source, 204 a compare portion for comparing the theoretical amount of power generation, which is calculated in the power generation amount calculating portion 202 mentioned above, and the actual amount of power generation by the distributed-type power source, which is measured by the electric power measuring portion 203 mentioned above, 205 a memory portion for memorizing therein a reliability estimation table for the distributed-type power source(s), which is/are installed within the consumer's household, and 206 a display portion for displaying that the parallel off is made when conducting the parallel off, respectively.

FIG. 3 is a view for showing the reliability estimation table according to the present embodiment. Details of steps for data registering onto the reliability estimation table will be mentioned later. A reference numeral 301 depicts a column of power source apparatus ID, for showing a power source apparatus ID, which uniquely identifies the distributed-type power source installed within the consumer's household, 302 a column for showing a sort or kind of the distributed-type power source, 303 a column for number of times when the difference between the theoretical amount of power generation and the actual amount of power generation comes outside a predetermined range, respectively. In the example shown in FIG. 3, for the distributed-type power source “a”, the power source apparatus ID is memorized to be “001”, the kind thereof to be “sunlight”, and the number of times of being outside the region to be “3”, for the distributed-type power source “b”, the power source apparatus ID is memorized to be “002”, the kind thereof to be “wind power”, and the number of times of being outside the region to be “10”, and for the distributed-type power source “c”, the power source apparatus ID is memorized to be “003”, the kind thereof to be “sunlight”, and the number of times of being outside the region to be “0”, respectively.

FIG. 8 shows an extended reliability estimation table obtained by extending the reliability estimation table shown in FIG. 3, wherein a number of times of errors of that distributed-type power source is added to the reliability estimation table shown in FIG. 3. A reference numeral 804 depicts a column for the number of times of errors for indicating the number of times of errors of that distributed-type power source. Herein, an error may be, not only the error of hardware, but also included an error of software. On the contrary, it may be only the error of the software. And, also, a kind of error may be weighted to have a degree of importance. However, the value on the column of the number of times of errors is incremented every time when an error occurs. In this manner, by adding the number of times of errors, too, it is possible to increase the reliability, further.

FIG. 15 shows the distributed-type power source enabled environment measuring apparatus table for making correspondence to an en environment measuring apparatus being suitable thereto. A reference numeral 1501 depicts a column for a kind of the distributed-type power source, and 1502 a column for an enabled environment measuring apparatus for showing an environment measuring apparatus being suitable for theoretical calculation of an amount of power generation for that distributed-type power source, with respect to the kind of that distributed-type power source. In the example shown in FIG. 15, for each solar power generating apparatus and for each wind power generating apparatus, the photometer and the anemometer (a wind gauge) are referred as the environment measuring apparatuses.

Hereinafter, explanation will be given on the details of processes for dealing the reliability estimation and the parallel off within the present embodiment, by referring to flowcharts shown in FIGS. 4 and 5.

FIG. 4 is a view of the flowchart for registering the reliability estimation table (see FIGS. 3 and 8) in the system connecting apparatus 101.

First of all, when the distributed-type power source is connected with the system connecting apparatus 101, a unique power source ID is assigned to that distributed-type power source, and is memorized into the column of power source apparatus ID 301 (step S401). Thereafter, the kind of that distributed-type power source apparatus is selected and inputted on the display portion 206, to be memorized into the column of kind 302 (step S402). However, although it is selected and then inputted, but kind information may be obtained from the distributed-type power source apparatus, which is connected, or may be estimated from a connecting form or the like, to be registered. Next, in case when using the number of times on the column of number of times of being outside the region 303 and the extended reliability estimation table shown in FIG. 8, the column of number of times of errors 804 is reset to “0” (step S403), and then a series of processes are ended.

Next, explanation will be given on the processes for executing the reliability estimation and the parallel off.

FIG. 5 is a flowchart for showing the processes for conducting the reliability estimation and the parallel off process in the system connecting apparatus 101. The present processing is conducted, cyclically, at a predetermined constant time-period. For example, the processing may be started upon basis of a timer interruption at a predestined interval, etc. Firstly, for the distributed-type power source, which is registered at a top of the reliability estimation table, an actual amount of power generation of that distributed-type power source is measured by the electric power measuring portion 203 (step S501). Next, in the power generation amount calculating portion 202, an environment measurement value is obtained from the environment measuring apparatus 102, which is suitable to the kind on the column of kind of the reliability estimation table, with using the distributed-type power source enabled environment measuring apparatus table (see FIG. 15) (step S502), and then the theoretical amount of power generation is calculated (step S503). the difference between the value measured in the step S501 and the value calculated in the step S503 is determined, if it lies within a predetermined range or not (step S504), and if it is outside the predetermined range, then determination is made that the reliability of that distributed-type power source is low, so that an increment is made on the value on the column of number of times of being outrange 303 of the reliability estimation table, and then is memorized (step S505). However, the predetermined range is determined to be a range of 7% with respect to the theoretical value calculated, for example, and it is memorized in the memory portion 205. Thereafter, the value on the column of number of times of being out range 303 is determined, if it exceeds the predetermined threshold value or not (step S506), and when it exceeds the threshold value, it is determined that the reliability of that distributed-type power source is low, so that the parallel off process for cutting off that distributed-type power source from the system is conducted, and each data of the power source apparatus ID, the kind and the number of times of being outrange, which are corresponding to that distributed-type power source, is deleted from the reliability estimation table (step S507). However, the threshold value in the step S506 is determined in advance, and it is memorized in the memory portion 205. Also, when using the extended reliability estimation table shown in FIG. 8, because also the value on the column of number of times of errors must be used therein, the threshold value in the step S506 is determined in advance, as well as, for the number of times of errors, to be memorized in the memory portion 205, while in case where one of the numbers of times exceeds the threshold value, or in case where both of them exceed the threshold values, the process advances to a step S508. After the step S507, a display of being in the parallel off is made on the display portion 206 (step S508), so as to inform thereof to a manager or a user of the consumer. After the step S508, in case of being not outside the predetermined range in the step S504, when the difference does not exceed the threshold value in the step S506, determination is made on whether the series of processes are executed or not, on all of the distributed-type power sources, which are described in the reliability estimation table (step S509), and if there is any distributed-type power source, on which the processes are not yet executed, then the process turns back to the step S501, so as to repeat the series of processes repetitively. If there is no distributed-type power source, on which the processes are not yet executed, then the series of processes are ended.

Next, explanation will be made on the processes for displaying an indication of making the parallel off, when being in the parallel off in the present embodiment. FIG. 13 is a view for showing a display on the display portion 206 in the system connecting apparatus 101 according to the present embodiment, wherein a reference numeral 1301 depicts an LED for indicating that the system connecting apparatus is in a normal condition, and this LED 1301 is turned ON when it is in a normal operation. A reference numeral 1302 depicts an LED for indicating that the parallel off is conducted, and this LED 1302 is turned ON when the parallel off process is conducted. A reference numeral 1303 depicts an LED for displaying the power source apparatus ID on the reliability estimation table, and display is made on the power source apparatus ID of the distributed-type power source, upon which the parallel off process is made. In the present embodiment, the display portion 206 is equipped in the system connecting apparatus 101; however it may be equipped with, in a separated housing connected with the system connecting apparatus 101. FIG. 14 is a view for showing a display screen, according to the present embodiment, wherein a reference numeral 1401 depicts a power source block for indicating that the power source apparatus ID on the reliability estimation table is the distributed-type power source of being “001”, and this displays thereon, the kind and/or the power source apparatus ID, an amount of power generation, and a non-reliability value for indication the number on the column of number of times of being outrange on the reliability estimation table. However, the non-reliability value may be obtained by using an inverse of the value on the column of number of times of being outrange, as a value for indicating the reliability. Reference numerals 1402 and 1403 depict the power source blocks, having the power source apparatus IDs “002” and “003”, respectively, indicating the same contents to that shown on the same column for the power source block 1401. Reference numerals 1404 and 1405 indicate the power consuming apparatus “A” and the power consuming apparatus “B”, respectively, and also an amount of power consumed, etc. A reference numeral 1406 depicts a parallel off icon for indicating the distributed-type power source being in the parallel off, and in the example shown in FIG. 14, it is indicated that the power source of the wind power is in condition of the parallel off. With those displays, for the consumer, it is possible to grasp a fact that the parallel off is conducted and/or the value of reliability, and the power source apparatus(es) being in the parallel off, easily. However, the displayed screen shown in FIG. 14 may be displayed, with applying a screen as the display portion 206 of the system connecting apparatus 101, or may be displayed on the separated housing (for example, a personal computer, etc.,) connected with the system connecting apparatus 101.

With such processes as mentioned above, it is possible to provide the system connecting apparatus for preventing ill-influences of troubles from being transferred to the system side, by estimating the reliability of the power source apparatus and conducting the parallel off process for cutting off the power source apparatus, being low in the reliability thereof.

### Embodiment 2

A present embodiment, comparing to the first embodiment, relates to the system connecting apparatus, in particular, in case where an instruction for suppressing or controlling an output (hereinafter, being called an “output suppression instruction”) is given, including an amount of suppression, for suppression of reverse power flow from the system side. However, the configuration of a system connecting system between the system and the consumers in the present embodiment is same to that shown in FIG. 1, a block diagram of the system connecting apparatus is same to that shown in FIG. 2, a reliability estimation table is same to that shown in FIGS. 3 and 8, a flowchart for executing the registration process of the reliability estimation table is same to that shown in FIG. 4, a view for showing a display on a display portion is same to that shown in FIG. 14, and an distributed-type power source enabled environment measuring apparatus table for making correspondence to an environment measuring apparatus being suitable thereto is same to that shown in FIG. 15; therefore, the explanation thereof will be omitted, herein.

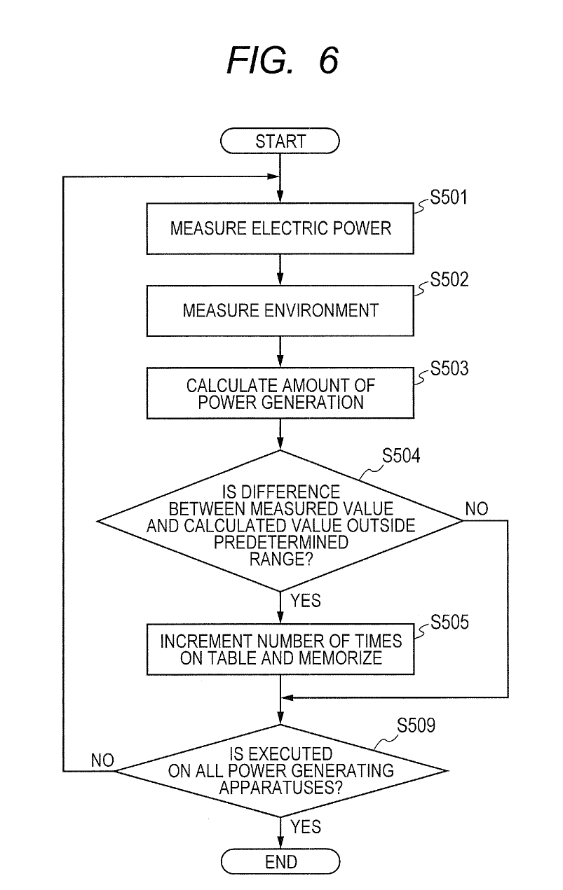

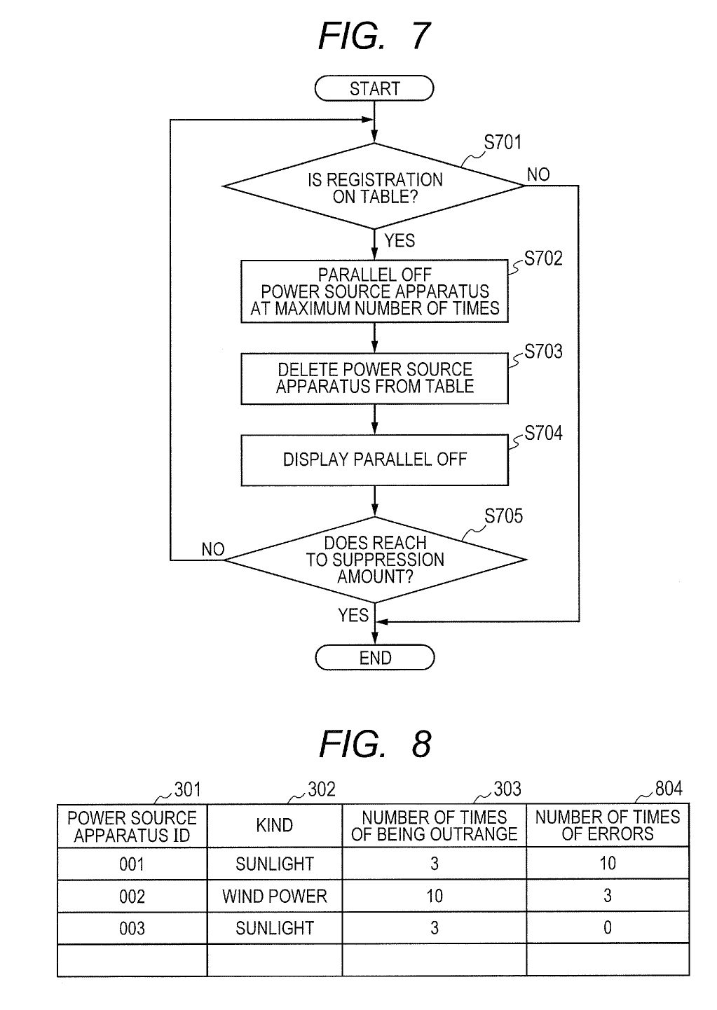

Explanation will be given on processing steps of the system connecting apparatus, according the present embodiment, by referring to FIGS. 6 and 7.

FIG. 6 is a flowchart for showing the processing steps for conducting the reliability estimation, in the system connecting apparatus according to the present embodiment, wherein almost of the processes are same to those of the flowchart shown in FIG. 5, and therefore explanation will be given only on the portion differing from the first embodiment. Comparing to the flowchart shown in FIG. 5, according to the first embodiment, in FIG. 6, processes starting from the step S506 to the step S508 are omitted. In other words, no threshold value is provided, and no parallel off process is executed on the distributed-type power source in the present processes. With this, because of a decrease of the number of the processes to be executed within a predetermined period, there can be obtained an effect of fastening a response speed of other processes.

Next, explanation will be given on the details of processing steps for executing the parallel off, when the output control instruction is given for the reverse power flow from the system side, by referring to FIG. 7. Herein, the output suppression instruction from the system may be given with using a power line or a power line communication, or the Internet, or a public network, such as, a telephone network, etc, or may be applied wireless for use of a satellite communication, a TV or a radio, etc., for example.

FIG. 7 is a flowchart for showing the processing steps for executing the parallel off, within the system connecting apparatus according to the present embodiment. The present processing is started by taking the opportunity of receiving the output suppression instruction including the amount of suppression, within the controller portion 201 from the system side 100. First of all, it is confirmed if the distributed-type power source is registered or not, on the reliability estimation table shown in FIG. 3 or on the extended reliability estimation table shown in FIG. 8 (step S701). If there is no registration, the series of the processes are ended, while informing that fact to the consumer. If there is registration in the step S701, the distributed-type power source, which has the maximum one among the values on the column of number of times of being outrange 303, is brought into the parallel off (step S702). Thereafter, a raw of that distributed-type power source is deleted from the reliability estimation table (step S703), and a display is made that the parallel off is made (step S704). A method for displaying is same to that of the embodiment 1. Further, if the extended reliability estimation table shown in FIG. 8 is applied, the distributed-type power source, being maximum among the values on the column of number of times of errors 804, may be in the parallel off, and/or if there are plural numbers of the distributed-type power sources, being maximum among the values on the column of number of times of being outrange 303, that being largest in the values on the column of number of times of being outrange 804. Or, that being maximum in a total value of a numerical value on the column of number of times of being outrange 303 and a numerical number on the column of number of times of being outrange 804 may be in the parallel off. In this manner, the reliability can be increased further, by taking also the number of times of errors into account. After the step S704, measurement is made on an amount of the reverse power flow within the consumer's household, to as to determine on whether the amount of the reverse power flow reaches or not, to an amount of suppression, which is received from the system side (step S705), and then if it does not reach to the amount of suppression, the process turns back to the step S701, so as to repeat the series of processes, repetitively. When the amount of reverse power flow reached to the amount of suppression in the step S705, the series of processes are ended.

With such processes mentioned above, e.g., estimating the reliability of the power source apparatus and executing the parallel off process for separating the power source apparatus having low reliability, it is possible to prevent the ill-influences due to troubles from being transferred to the system side, and also since no control is made on the amount of power generation of the distributed-type power source, it is possible to provide the system connecting apparatus, also enabling to deal with the suppression of the revere power flow, while reducing a load on each of the distributed-type power sources.

### Embodiment 3

A present embodiment relates, comparing to the first embodiment, to a system connecting apparatus for estimating the reliability with using a value obtained, while obtaining a measured value of the amount of power generation of the distributed-type power sources from the consumers neighboring with, but not doing calculating of the theoretical amount of power generation with using the measured value of the environment measuring apparatus. However, in the present embodiment, since a reliability estimation table is same to that shown in FIGS. 3 and 8, a flowchart for conducting the registering process of the reliability estimation table is same to that shown in 4, the figure for showing a display on the display portion is same to that shown in FIG. 13, the figure for showing a display screen is same to that shown in FIG. 14, and an distributed-type power source enabled environment measuring apparatus table for making correspondence to an environment measuring apparatus being suitable thereto is same to that shown in FIG. 15; therefore, the explanation thereof will be omitted, herein.

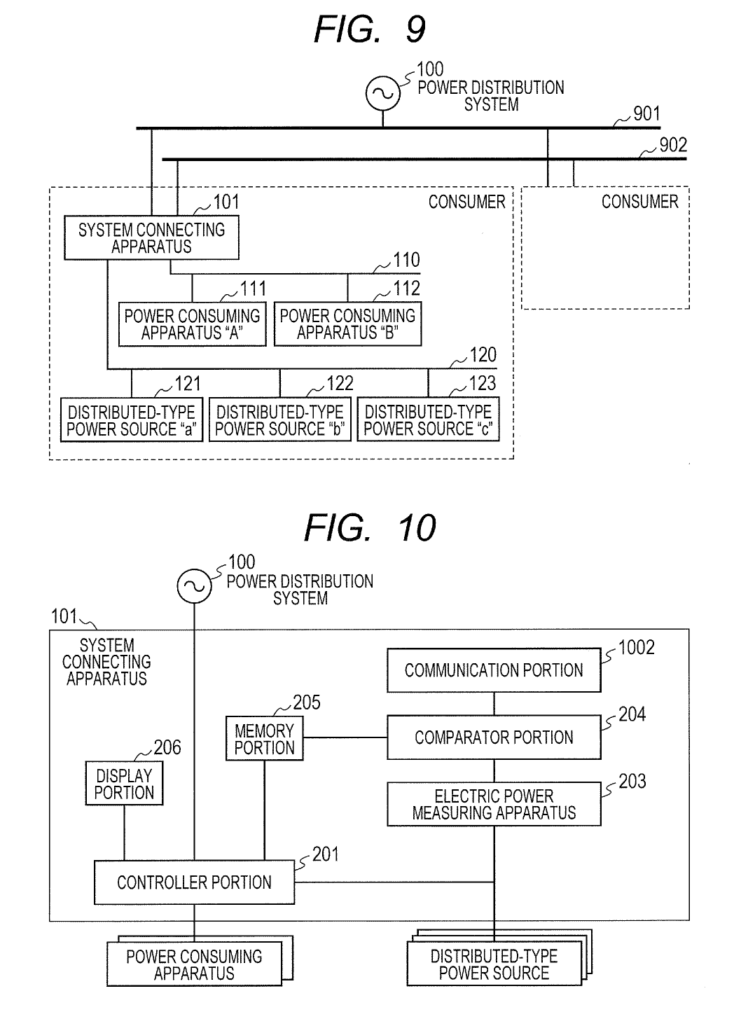

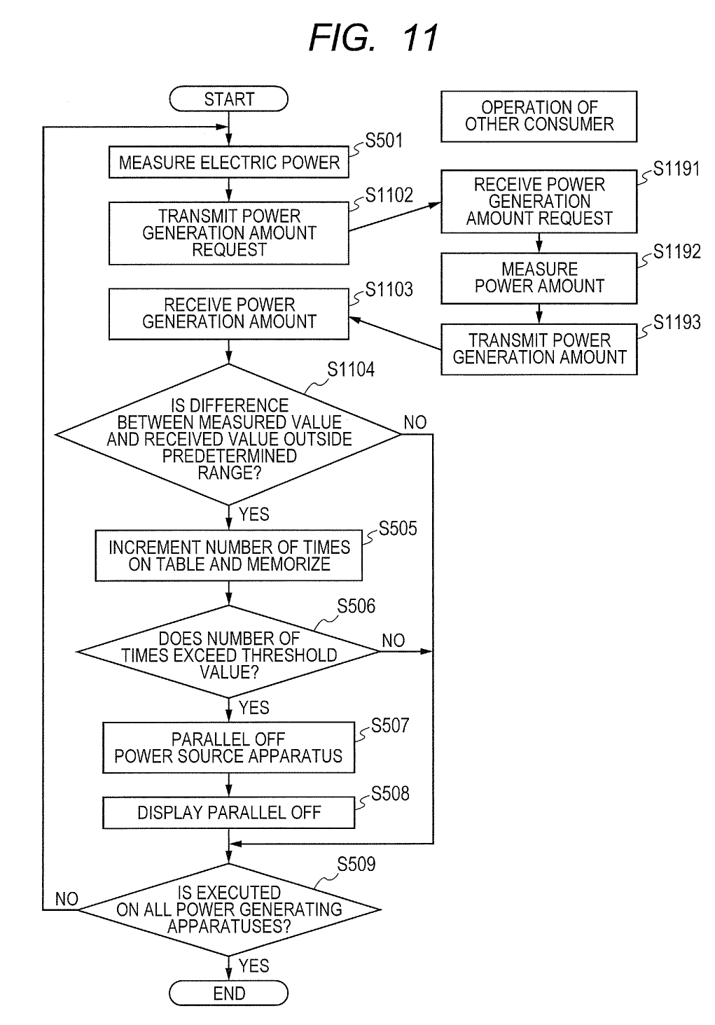

FIG. 9 is a view for showing the configuration of a system connecting system between the system and the consumers, according to the present embodiment, FIG. 10 is a block diagram of a system connecting apparatus according to the present embodiment, and FIG. 11 is a flowchart for conducting the estimation of reliability and the parallel off process in the system connecting apparatus of the present embodiment.

In FIG. 9, since almost thereof are same to those shown in FIG. 1, explanation will be made on only the portions differing from that. A reference numeral 901 depicts a power line lying between the system 100 and each of the consumers, and 902 a communication line for conducting data transmission between the consumers applying the Internet therein. However, in case where a power line communication is applied for the communication, only the power line is sufficient, and there is no necessity of laying the communication line, separately. Also, the wireless may be applied to the communication line 902. In FIG. 9, since the environment measuring apparatus 102 shown in FIG. 1 is not necessary, and therefore it is deleted therefrom.

FIG. 10 is a block diagram of the system connecting apparatus, according to the present embodiment. Almost of the constituent blocks are same to those shown in FIG. 2, explanation will be given only on the portions differing from those. A reference numeral 1002 depicts a communication portion for conducting communication between other consumers via the communication line 902 mentioned above, and it can substitute for the power generation amount calculating portion 202 shown in FIG. 1. For that reason, the power generation amount calculating portion 202 is not necessary in FIG. 10, and therefore it is deleted from.

Hereinafter, explanation will be made on the details of steps of the reliability estimation and the parallel off process in the present embodiment, by referring to a flowchart shown in FIG. 11. However, since the processing for registering the reliability estimation table is same to that of the first embodiment shown in FIG. 4, and therefore the explanation thereof will be omitted herein.

FIG. 11 is a flowchart for showing the processing steps for conducting the reliability estimation and the parallel off process in the system connecting apparatus 101. The present processing is conducted, cyclically, at a predetermined constant time-period. For example, the processing may be started upon basis of a timer interruption at a predestined interval, etc. Almost of the processing steps shown in FIG. 11 are same to those shown in FIG. 5; however, for the purpose of clearing the details of the processes, explanation will be made in duplicate. But, the portion(s) same to that shown in FIG. 5 will be explained, by referring to the same step numbers shown in FIG. 5. Firstly, for the distributed-type power source, which is registered at a top of the reliability estimation table, an actual amount of power generation of that distributed-type power source is measured by the electric power measuring portion 203 (step S501). Next, to the system connecting apparatus of other consumers neighboring with, a command for requesting an amount of power generation in the distributed-type power source of the kind on the column of kind of the reliability estimation table is sent, from the communication portion 1002 (step S1102). Herein, a partner of communication may be the consumer, which is registered in advance, or a broadcast may be made to all of the consumers within an area. When other consumer receives the command for requesting an amount of power generation, which is transmitted in the step S1102 (step S1191), measurement is made on the amount of electric power of the distributed-type power source (s) requested (step S1192), and the amount of electric power measured is transmitted to the consumer, being an origin of the transmission (step S1193). However, if there is no such kind of the distributed-type power source as requested, an indication of that is transmitted to the consumer, being the origin of the transmission. The system connecting apparatus 101 in the consumer, being the origin of the transmission of the command for requesting the amount of power generation, receives the amount of power generation, which is transmitted in the step S1193 mentioned above, within the communication portion 1002 (step S1103). Also, when receiving a command indicating that there is no such kind of the distributed-type power source as requested, without conducting the steps thereafter for the distributed-type power source, the process is shifted to the step S509. Determination is made if the difference lies within a predetermined range or not, between a measured value measured in the step S1104 and a measured value of the amount of power generation of the neighboring consumers, which is received in the step S1203 (step S1204), and if it is outside the predetermined range, determination is made that there is a possibility that the distributed-type power source is low in the reliability thereof, and then the value on the column of number of times of being outrange 303 of the reliability estimation table is incremented and memorized (step S505). However, the predetermined range is determined to be a range of 7% with respect to the theoretical value calculated, for example, and it is memorized in the memory portion 205. Thereafter, the value on the column of number of times of being out range 303 is determined, if it exceeds the predetermined threshold value or not (step S506), and when it exceeds the threshold value, it is determined that the reliability of that distributed-type power source is low, so that the parallel off process for cutting off that distributed-type power source from the system is conducted, and each data of the power source apparatus ID, the kind and the number of times of being outrange, which are corresponding to that distributed-type power source, is deleted from the reliability estimation table (step S507). However, the threshold value in the step S506 is determined in advance, and it is memorized in the memory portion 205. Also, when using the extended reliability estimation table shown in FIG. 8, because also the value on the column of number of times of errors must be used therein, the threshold value in the step S506 is determined in advance, as well as, for the number of times of errors, to be memorized in the memory portion 205, while in case where one of the numbers of times exceeds the threshold value, or in case where both of them exceed the threshold values, the process advances to a step S508. After the step S507, a display of being in the parallel off is made on the display portion 206 (step S508), so as to inform thereof to a manager or a user of the consumer. After the step S508, in case of being not outside the predetermined range in the step S504, when the difference does not exceed the threshold value in the step S506, determination is made on whether the series of processes are executed or not, on all of the distributed-type power sources, which are described in the reliability estimation table (step S509), and if there is any distributed-type power source, on which the processes are not yet executed, then the process turns back to the step S501, so as to repeat the series of processes repetitively. If there is no distributed-type power source, on which the processes are not yet executed, then the series of processes are ended.

With such processes mentioned above, e.g., estimating the reliability of the power source apparatus and executing the parallel off process for separating the power source apparatus having low reliability, it is possible to provide the system connecting apparatus, for preventing the ill-influences due to troubles from being transferred to the system side. Also, with using the measured value of the amount of power generation of the neighboring consumers, for the estimation of reliability, since no environment measuring apparatus nor the portion for calculating the amount of power generation is necessary, therefore the apparatus can be achieved with low costs.

### Embodiment 4

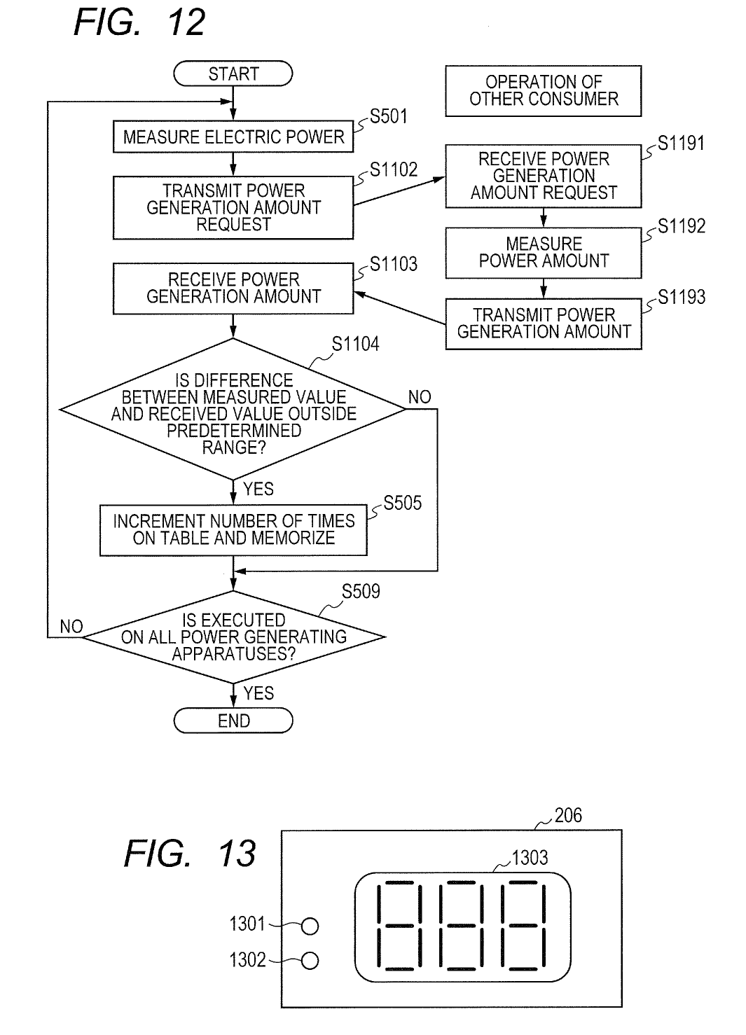

A present embodiment relates, comparing to the third embodiment, to a system connecting apparatus, in particular, when there is an instruction, i.e., the output suppression instruction mentioned above, including the amount of suppressing, for suppressing the reverse power flow from the system side. However, the configuration of a system connecting system between the system and the consumers in the present embodiment is same to that shown in FIG. 9, a block diagram of the system connecting apparatus is same to that shown in FIG. 10, a reliability estimation table is same to that shown in FIGS. 3 and 8, a flowchart for executing the registration process of the reliability estimation table is same to that shown in FIG. 4, a view for showing a display on a display portion is same to that shown in FIG. 14, and an distributed-type power source enabled environment measuring apparatus table for making correspondence to an environment measuring apparatus being suitable thereto is same to that shown in FIG. 15; therefore, the explanation thereof will be omitted, herein. Also, as a flowchart showing steps for processing the parallel off within the system connecting apparatus can be applied the flowchart same to that shown in FIG. 7, within the second embodiment, the explanation thereof will be omitted, herein. Hereinafter, explanation will be given on the processing steps of the system connecting apparatus according to the present embodiment, by referring to FIG. 12.

FIG. 12 is a flowchart showing the processing steps for conducting the reliability estimation within the system connecting apparatus according to the present embodiment, wherein almost of the processes are same to those in the flowchart shown in FIG. 11, and therefore, explanation will be given only on a portion differing from that of the third embodiment. Comparing to the flowchart in FIG. 11, explained in the third embodiment, in FIG. 12, those processes of the step S506 to the step S508 are omitted. Thus, no threshold value is provided, nor the parallel off process of the distributed-type power source is conducted, in the present processing. With this, because of a decrease of the number of the processes to be executed within a predetermined period, there can be obtained an effect of fastening a response speed of other processes.

Next, in case where the output suppressing instruction or command is given for suppressing the reverse power flow from the system side, processing for conducting the parallel off is executed; however the processing steps for conducting the parallel off in the present embodiment are same to those shown in FIG. 7, e.g., the second embodiment, and therefore the explanation thereof will be omitted, herein.

With such processes mentioned above, e.g., estimating the reliability of the power source apparatus and executing the parallel off process for separating the power source apparatus having low reliability, it is possible to prevent the ill-influences due to troubles from being transferred to the system side, and also since no control is made on the amount of power generation of the distributed-type power source, it is possible to provide the system connecting apparatus, also enabling to deal with the suppression of the revere power flow, while reducing a load on each of the distributed-type power sources. Also, with using the measured value of the amount of power generation of the neighboring consumers, for the estimation of reliability, since no environment measuring apparatus nor the portion for calculating the amount of power generation is necessary, therefore the apparatus can be achieved with low costs.

However, the present invention should not be restricted to the embodiments mentioned in the above, but may includes therein various variations thereof. For example, the embodiments mentioned above are explained in details thereof, for the purpose of easy understanding thereof, and therefore, the present invention should not be limited to that having all of the constituent elements thereof.

Also, a part of the constituent elements of a certain embodiment can be substituted with the constituent element of the other embodiment (s), or the constituent element of other embodiment (s) may be added to a part of the constituent element of a certain embodiment. Also, regarding a part of the constituent elements of each embodiment, it may be added/deleted/substituted with other constituent element (s).

Also, each constituent element, function, processing unit, processing means, etc., mentioned above, a part or all thereof may be achieved with hardware, such as, by designing it with an integrated circuit, etc. Also, each constituent element or function, etc., mentioned above may be achieved in the form of software, wherein a processor interprets programs for achieving the respective functions and executes them. The information of the programs, tables or files, etc., for achieving each function may be located in a recording device, such as, a memory, a hard disc, a SSD (Solid State Drive), etc., or a recoding medium, such as, an IC card, a SD card, a DVD, etc.

Also, control lines and/or information lines are shown, which can be considered to be necessary for the explanation, but all of the control lines and the information lines, which are necessary for a product, are not shown, necessarily. Actually, it can be considered that almost of all constituent elements are connected, mutually, with each other.

What is claimed is:

1. A power distribution system connecting apparatus, for supplying AC power received to plural numbers of power consuming apparatuses, or for supplying AC power generated to the power consuming apparatuses or a power distribution system, within a system for a consumer, for receiving the AC power transmitted from the power distribution system, having plural numbers of power source apparatuses for generating the AC power, and plural numbers of the power consuming apparatuses, comprising:
a power generation amount calculating portion, which is configured to calculate a theoretical amount of power generation of one (1) set of power source apparatus;
a power measuring portion, which is configured to measure an actual amount of power generation of one (1) set of power source apparatus;
a comparator portion, which is configured to compare said theoretical amount of power generation and said actual amount of power generation; and
a controller portion, which is configured to execute a parallel off process for cutting off said one (1) set of power source, when a number of times when said actual amount of power generation does not reach said theoretical amount of power generation, by a predetermined value or more, exceeds a predetermined number of times.

2. The power distribution system connecting apparatus, as described in the claim 1, further comprising display portion for displaying thereon, that said parallel off process is executed, a power source apparatus, upon which said parallel off process is executed, a connecting condition with each of the power source apparatuses, or the number of times of not satisfying said number of times when said actual amount of power generation does not reach said theoretical amount of power generation, by the predetermined value or more.

3. A power distribution system connecting apparatus, for supplying AC power received to plural numbers of power consuming apparatuses, or for supplying AC power generated to the power consuming apparatuses or a power distribution system, within a system for a consumer, for receiving the AC power transmitted from the power distribution system, having plural numbers of power source apparatuses for generating the AC power, and plural numbers of the power consuming apparatuses, comprising:
a power generation amount calculating portion, which is configured to calculate a theoretical amount of power generation of one (1) set of power source apparatus;
a power measuring portion, which is configured to measure an actual amount of power generation of one (1) set of power source apparatus;
a comparator portion, which is configured to compare said theoretical amount of power generation and said actual amount of power generation; and
a memory portion for memorizing therein a number of times when said actual amount of power generation does not reach said theoretical amount of power generation, by a predetermined value or more, for each power source, and further comprising
a controller portion, which is configured to execute a parallel off process for cutting off a power source apparatus, the number of times of which, being memorized in said memory portion, is largest, from the power distribution system, when receiving an instruction of suppression of a reverse power flow from said power distribution system.

4. The power distribution system connecting apparatus, as described in the claim 3, further comprising display portion for displaying thereon, that said parallel off process is executed, a power source apparatus, upon which said parallel off process is executed, a connecting condition with each of the power source apparatuses, or the number of times of not satisfying said number of times when said actual amount of power generation does not reach said theoretical amount of power generation, by the predetermined value or more.

5. A power distribution system connecting apparatus, for supplying AC power received to plural numbers of power consuming apparatuses, or for supplying AC power generated to the power consuming apparatuses or a power distribution system, within a system for a consumer, for receiving the AC power transmitted from the power distribution system, having plural numbers of power source apparatuses for generating the AC power, and plural numbers of the power consuming apparatuses, comprising:
a communication portion, which is configured to receive an amount of power generation of power source apparatuses of other consumer, being same in kind thereof, for one (1) set of power source apparatus;
a power measuring portion, which is configured to measure an actual amount of power generation of one (1) set of power source apparatus;
a comparator portion, which is configured to compare said theoretical amount of power generation and said actual amount of power generation; and
a controller portion, which is configured to execute a parallel off process for cutting off said one (1) set of power source, when a number of times when said actual amount of power generation does not reach said theoretical amount of power generation, by a predetermined value or more, exceeds a predetermined number of times.

6. The power distribution system connecting apparatus, as described in the claim 5, further comprising display portion for displaying thereon, that said parallel off process is executed, a power source apparatus, upon which said parallel off process is executed, a connecting condition with each of the power source apparatuses, or the number of times of not satisfying said number of times when said actual amount of power generation does not reach said theoretical amount of power generation, by the predetermined value or more.

7. A power distribution system connecting apparatus, for supplying AC power received to plural numbers of power consuming apparatuses, or for supplying AC power generated to the power consuming apparatuses or a power distribution system, within a system for a consumer, for receiving the AC power transmitted from the power distribution system, having plural numbers of power source apparatuses for generating the AC power, and plural numbers of the power consuming apparatuses, comprising:
a communication portion, which is configured to receive an amount of power generation of power source apparatuses of other consumer, being same in kind thereof, for one (1) set of power source apparatus;
a power measuring portion, which is configured to measure an actual amount of power generation of one (1) set of power source apparatus;
a comparator portion, which is configured to compare said theoretical amount of power generation and said actual amount of power generation; and
a memory portion for memorizing therein a number of times when said actual amount of power generation does not reach said theoretical amount of power generation, by a predetermined value or more, for each power source, and further comprising
a controller portion, which is configured to execute a parallel off process for cutting off a power source apparatus, the number of times of which, being memorized in said memory portion, is largest, from the power distribution system, when receiving an instruction of suppression of a reverse power flow from said power distribution system.

8. The power distribution system connecting apparatus, as described in the claim 7, further comprising display portion for displaying thereon, that said parallel off process is executed, a power source apparatus, upon which said parallel off process is executed, a connecting condition with each of the power source apparatuses, or the number of times of not satisfying said number of times when said actual amount of power generation does not reach said theoretical amount of power generation, by the predetermined value or more.
